(19) United States
(12) Patent Application Publication
(10) Pub. No.: US 2026/0184141 A1
(43) Pub. Date: Jul. 2, 2026

(54) VEHICULAR SLIDING WINDOW ASSEMBLY

(71) Applicant: Magna Exteriors, Inc., Troy, MI (US)

(72) Inventor: Arnaud Rollin, Noidant Le Rocheux (FR)

(21) Appl. No.: 19/421,375

(22) Filed: Dec. 16, 2025

Related U.S. Application Data
(60) Provisional application No. 63/739,317, filed on Dec. 27, 2024.
(60) Provisional application No. 63/747,539, filed on Jan. 21, 2025.

(51) Int. Cl. B60J 1/18

(52) U.S. Cl. CPC B60J 1/1853

(57) ABSTRACT

A sliding closure arrangement for a vehicle that includes a frame. The frame has a guide rail for slidably receiving a closure that is moveable in response to an opening direction force, where the closure moves along the guide rail toward an opened position and a closing direction force, where the closure moves along the guide rail toward a closed position. The closure is movable to one or more intermediate positions between the opened position and the closed position. To facilitate the locking, unlocking, and positioning of the closure along the guide rail there is a handle lock mechanism that controls the locking and unlocking of a blocking mechanism. The blocking mechanism includes a rotatable foot that is engageable with one of a plurality of detents positioned along the guide rail.

### CROSS REFERENCE TO RELATED APPLICATIONS

The present application claims the filing benefits of U.S. provisional application Ser. No. 63/747,539, filed Jan. 21, 2025, and U.S. provisional application Ser. No. 63/739,317, filed Dec. 27, 2024, which are hereby incorporated herein by reference in their entireties.

### FIELD OF THE INVENTION

The present invention relates generally to movable or slider window assemblies for vehicles and, more particularly to a side or rear slider window assembly for a vehicle such as a pickup truck or the like.

### BACKGROUND OF THE INVENTION

In the automotive field, sliding window assemblies are used to provide for easily opening and closing a section of a window. Sliding windows are used for rear cab windows, side cab windows, bus driver windows, and the like. Many of these assemblies have a great number of components because they typically allow for positioning the window at several intermediate positions between the fully opened and closed positions. Also, these windows must provide anti-intrusion features that prevents them from being forced open. Additionally, it is desirable to provide an arrangement that prevents persons, such as small children, from having their fingers or hands pinched in the components of the sliding window arrangement.

There is a need to provide a sliding window arrangement that has a reduced number of components, thereby reducing cost. It is further desirable to provide a sliding window arrangement that limits the number of moving components, and consequently to limit the frictional forces between each component to allow the sliding window to move more freely and also to protect persons from getting pinched by the components. It is further desirable to provide a sliding window arrangement that provides anti-intrusion features that prevent an average person attempting to force open the moving assembly to enter the vehicle.

### SUMMARY OF THE INVENTION

A sliding closure arrangement for a vehicle includes a frame defining an aperture. The frame has at least one side with a guide rail for slidably receiving a closure that is moveable in response to (i) an opening direction force where the closure moves along the guide rail toward an opened position and (ii) a closing direction force where the closure moves along the guide rail toward a closed position. The closure is moveable to one or more intermediate positions between the opened position and the closed position. A handle lock mechanism is connected to a carrier of the closure and includes a locking handle and an opening handle. The locking handle includes at least one lock stop. The locking handle is rotatable to move the at least one lock stop between a locked position and an unlocked position. The locking handle includes a bias lock spring for biasing the at least one lock stop toward the locked position. The handle lock mechanism includes an opening handle having an aperture for receiving the at least one lock stop when the locking handle is rotated to the locked position. The opening handle includes a return spring that pushes against the opening handle to bias the opening handle in a direction so that the at least one lock stop moves into the aperture positioning the locking handle in the locked position. The opening handle includes a rack having a plurality of teeth for engaging at least one of a plurality of toothed pins rotatably connected to a rod. A blocking mechanism is in sliding contact with the guide rail of the frame. The blocking mechanism is connected to the carrier of the closure, and the blocking mechanism is operably connected to the handle lock mechanism through the rod. The blocking mechanism includes a blocking spring connected between the carrier and a foot where forces are exerted on the foot. A detent is formed in the guide rail, and the foot of the blocking mechanism slides in the guide rail. A foot spring biases the foot to rotate to an engaged position where the foot engages the detent to hold the blocking mechanism and the closure at a location on the guide rail until the opening direction force or closing direction force is exerted on the handle locking mechanism to overcome the force of the blocking spring to move the foot to a released position where the foot is released from the detent.

These and other objects, advantages, purposes and features of the present invention will become apparent upon review of the following specification in conjunction with the drawings.

### BRIEF DESCRIPTION OF THE DRAWINGS

FIG. 1 is a rear perspective view of a pickup truck having a rear slider window assembly;

FIG. 2 is a schematic diagram of the first embodiment of the present invention;

FIG. 3 is a schematic diagram of the first embodiment of the present invention;

FIG. 4 is a schematic diagram of the first embodiment of the present invention;

FIG. 5 is a schematic diagram of the first embodiment of the present invention;

FIG. 6 is a schematic diagram of the first embodiment of the present invention; and

FIG. 7 is a schematic diagram of the first embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

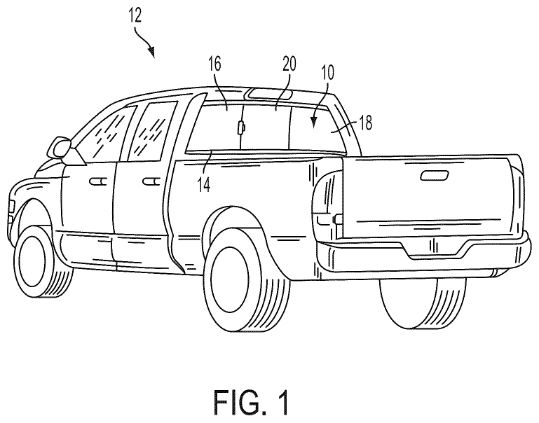

Referring now to the drawings and the illustrative embodiments depicted therein, a rear slider window assembly 10 of a vehicle 12 (such as a pickup truck or the like) includes a window frame 14, a pair of side fixed window panel 16, 18 and a movable window panel 20 that is movable relative to the window frame 14 and the fixed window panels 16, 18 (FIG. 1). The fixed window panels 16, 18 may be spaced from one another to define an opening or aperture between the fixed window panels 16, 18. Optionally, the window assembly 10 includes a single fixed window panel having an opening between opposing sides or portions of the fixed window panel. The movable window panel 20 is movable between a closed position, where the movable window panel 20 is disposed at the aperture between the fixed window panels 16, 18, and an opened position, where the movable window panel 20 is moved at least partially along one of the fixed window panels 16, 18 (or along one side or portion of the singular fixed window panel).

The movable window panel 20 includes or is part of a sliding closure arrangement 10 for the vehicle 12. That is, the sliding closure 10 includes a sliding window 20, or it may include a panel for opening and closing an aperture on the vehicle 12. The sliding closure arrangement 10 includes a frame 14 at least partially defining the aperture, and the frame 14 has at least one side with a guide rail 22 for slidably receiving the closure or panel 20 that is moveable in response to an opening direction force, where the closure or panel 20 moves along the guide rail 22 toward an opened position and a closing direction force, where the closure or panel 20 moves along the guide rail 22 toward a closed position (FIGS. 5-7). There is also one or more intermediate positions where the closure panel 20 is positioned between the opened position and the closed position. The guide rail 22 may be just along one side of the aperture or there may be multiple guide rails on multiple sides of the aperture. It is also within the scope of the disclosure for there to be two guide rails in parallel at opposing sides of the frame 14.

In other words, the guide rail 22 may be disposed at a lower portion of the frame 14 that extends along a lower perimeter edge region of the fixed window panels 16, 18 and/or the guide rail 22 may be disposed at an upper portion of the frame 14 that extends along an upper perimeter edge region of the fixed window panels 16, 18. Thus, the lower perimeter edge region of the movable panel 20 may be movably supported by the lower portion of the frame 14 and the upper perimeter edge region of the movable panel 20 may be movably supported by the upper portion of the frame 14.

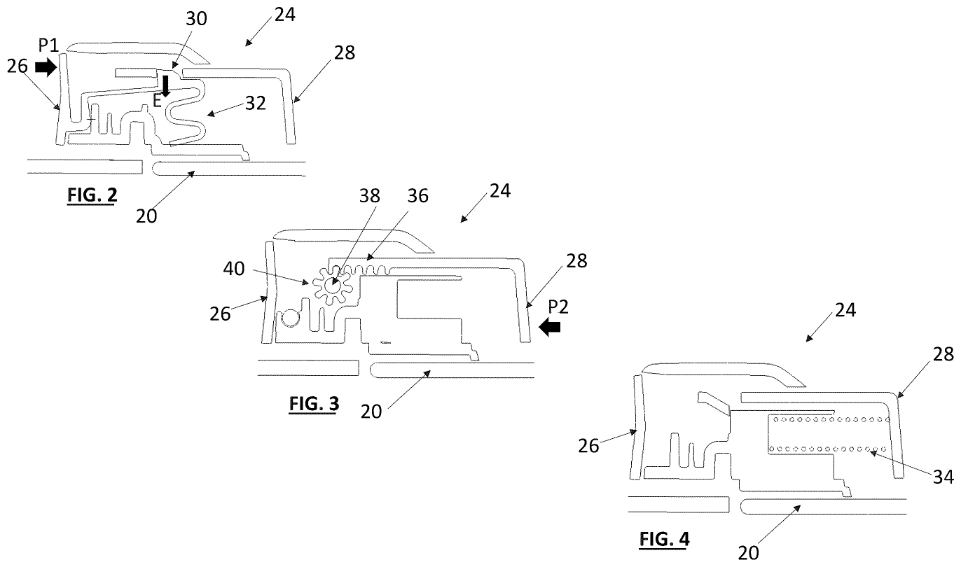

To facilitate the locking, unlocking, and positioning of the closure or panel 20 along the guide rail 22 of the frame 14, the sliding closure arrangement 10 includes a handle lock mechanism 24 and a blocking mechanism, which will be described below (FIGS. 2-4). The handle lock mechanism 24 is connected to a carrier of the closure or panel 20 and has a locking handle 26 and an opening handle 28. For example, the carrier is disposed in at least one of the lower portion of the frame 14 and the upper portion of the frame 14 to enable movement of the movable window panel 20 relative to the frame 14 and the fixed window panels 16, 18. The carrier may be overmolded at a perimeter edge region of the movable window panel 20 (e.g., an upper perimeter edge region, a lower perimeter edge region, and/or a side perimeter edge region) and the handle lock mechanism 24 may be integrally formed with or coupled to the carrier. The locking handle 26 includes at least one lock stop 30, and the locking handle 26 is rotated to move the at least one lock stop 30 between a lock position and an unlock position. The lock handle 26 has a bias lock spring 32 of the locking handle 26 for biasing the lock stop 30 toward the lock position. The bias lock spring 32 is an integral extension from a surface of the handle 26, however, it is within the scope of this disclosure for the bias lock spring 32 to be a separate component.

The handle lock mechanism 24 further includes the opening handle 28 having an aperture for receiving the at least one lock stop 30 when the locking handle 28 is rotated to the lock position. The opening handle 28 further includes a return spring 34 that pushes against the opening handle 28 to bias the opening handle 28 in a direction so that the at least one lock stop 30 moves into the aperture to position the locking handle 26 in the lock position. The opening handle 28 further includes a rack 36 having a plurality of teeth for engaging at least one of a plurality of toothed pins rotatably connected to a rod 38 to form a pinion 40. This allows for the return spring 34 to assert torsional forces on the rod 38 through the rack 36 of the opening handle 28.

The sliding closure arrangement further includes a blocking mechanism in sliding contact with the guide rail 22 of the frame 14 (FIGS. 5-7). The blocking mechanism is connected to the carrier 54 of the closure or panel 20 and operably connected to the handle lock mechanism 24 through the rod 38. The blocking mechanism includes a blocking spring connected between a collar 56 (e.g., a flange or rim) of the carrier 54 and a foot 42 of the blocking mechanism, connectable to the rod 38.

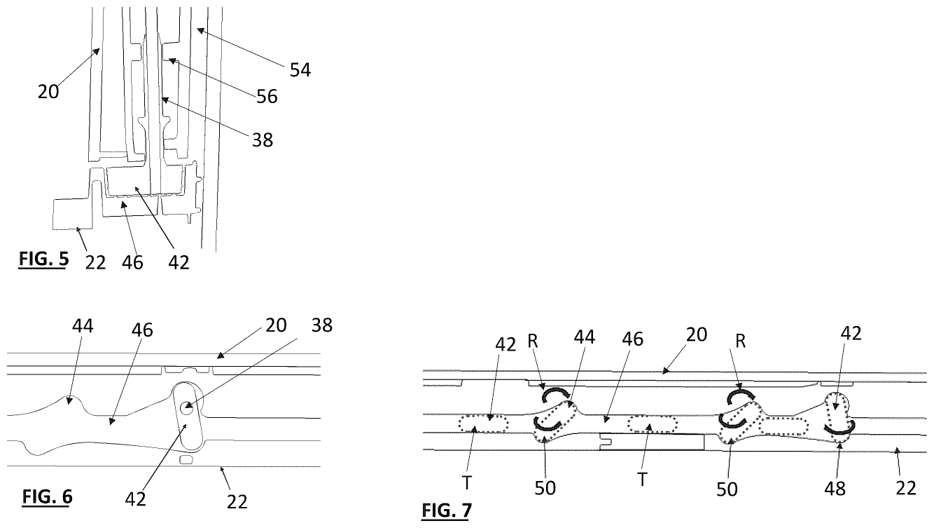

The guide rail 22 of the frame 14 further includes at least one detent 44 formed in the guide rail 22. As shown in FIGS. 6 and 7, there are a plurality of detents 44, which include a fully closed detent, a fully open detent 48, and a plurality of intermediate detents 50. The blocking mechanism engages each of the detents 44 to hold the closure or panel 20 at a specific location, until the blocking mechanism is unlocked. More specifically, the foot 42 of the blocking mechanism slides in a groove 46 of the guide rail 22 and a foot spring or blocking spring biases the foot 42 to rotate to an engaged position where the foot 42 engages the detent 44 to hold the blocking mechanism and the closure or panel 20 at a location on the guide rail 22 until the opening direction force or closing direction force is exerted on the handle locking mechanism 24 to overcome the force of the blocking spring to move the foot 42 to a released position where the foot 42 is released from the detent 44.

FIG. 2 shows a sectional view of the area of the handle 24 of a device according to the invention.

The device for opening, closing, locking and unlocking the movable panel 20 which is displaceable relative to a vehicle opening, in particular a sliding window in a window opening of a motor vehicle, includes guide rails 22 fixed to the vehicle opening (as shown in FIGS. 5-7) and the rod 38 which is displaceable with the panel 20. The rod 38 has the foot 42 at an axial end of the rod 38 (FIG. 5) which is rotationally fixed relative to the rod 38. The foot 42 is guided in the guide rail 22.

As shown in FIGS. 2-4, the device comprises the handle 24. The handle 24 has the opening handle part 28 (FIG. 3), so that when the opening handle part 28 is actuated in translation by supplying a force or pressure P2 to the opening handle part 28 in the direction indicated in FIG. 3, the rod 38 is subjected to a rotational force by engagement of a rack 36 in a pinion 40 (FIG. 3).

In this way the foot 42 at the axial end of the rod 38 is subjected to a rotational force. The handle 24 has a locking handle part 26 (FIG. 2), so that when the locking handle part 26 is actuated, such as by supplying a force or pressure P1 to the locking handle part 26 in the direction indicated in FIG. 2, the opening handle part 28 is released from a locked position, in which the opening handle part 28 cannot be actuated, into an unlocked position, so that the opening handle part 28 can be actuated, such as in the way shown in FIG. 3.

As shown in FIG. 4, the handle 24 comprises the return spring 34 that counteracts the translational actuation of the opening handle part 28, i.e. that causes the opening handle part 28 to return into its original position after actuation, in the direction opposite to the direction of pressure P2 in FIG. 3.

The locking handle part 26 is actuated translationally (e.g., by applying pressure P1 as shown in FIG. 2) and thereby performs at least in part a pivoting movement to release the opening handle part 28 into the unlocked position. For example, see at least partial movement of locking handle part 26 in the direction E in FIG. 2. The locking handle part 26 has the stop 30 which engages in the opening handle part 28 in the locked position of the opening handle part 28 and is swung out of the engagement when the locking handle part 26 is actuated.

The locking handle part 26 is translationally actuated in a direction opposite to the translational actuation of the opening handle part 28. The locking handle part 26 is translationally actuated toward the opening handle part 28 (FIG. 2) and the opening handle part 28 is translationally actuated toward the locking handle part 26 (FIG. 3).

As shown in FIGS. 5-7, the foot 42 is guided in the groove 46 of the guide rail 22. The groove 46 has bays or detents 44, one at an intended end position 48 and several at intended intermediate positions 50 in which the panel 20 shall have defined semi-opened positions. The bays 44 are wider than the groove 46 in other regions and thereby allows greater rotation of the foot 42 than in other sections of the guide rail 22.

The foot 42, in a plane normal to the rod 38, has an elongate shape (FIG. 6). When the opening handle part 28 is actuated in translation, a rotational force is applied to the rod 38 so that a rotational force (see R in FIG. 7) is applied to the foot 42 at the axial end of the rod 38, so that the elongate shape is aligned parallel to the groove 46 and, when the opening handle part 28 is moved in translation against the direction of actuation, the foot 42 at the axial end of the rod 38 is subjected to a rotational force (see R in FIG. 7), so that the elongate shape is rotated into the bay 44 in a section of the groove 46 which has a bay 44.

When the elongate shape of the foot 42 is aligned parallel to the groove 46, the foot 42 and therefore the rod 38 and the panel 20 can be moved along the groove 46 and along the guide rail 22, by pushing or pulling the handle 24.

Ribs are formed on the surface of the groove 46 facing the foot 42 or on the surface of the foot 42 facing the groove 46, in order to reduce the friction between the foot 42 and the groove 46.

In some examples, and such as shown in FIG. 5, the rod 38 extends within the overmold carrier 54 at least partially between the handle 24 and the foot 42. The overmold carrier 54 may include a threaded surface that engages the rod 38 (or optionally a portion of the foot 42 that extends partially along the rod 38) so that when the rod 38 and foot 42 rotate relative to the carrier 54, the threaded surface threadably engages the rod 38 and/or foot 42 and the rod 38 and/or foot 42 may move axially in a direction parallel to the longitudinal axis of the rod 38 relative to the carrier 54. This may cause the foot 42 to lift at least partially from the groove 46 when the movable panel 20 is moving and cause the foot 42 to move toward engagement with the bottom of the groove 46 when the movable panel 20 is stopped at a detent position.

Further, the foot spring or blocking spring may be disposed at the overmold carrier 54 to urge the foot 42 into the engaged position. For example, the foot spring may be disposed between the foot 42 and the carrier 54. Optionally, the foot spring may be internal to the carrier 54, such as disposed between the collar 56 formed within the carrier 54 and a lip or engaging portion formed at the rod 38 and/or foot 42 (FIG. 5). This may capture the foot spring within the carrier 54, allowing the foot spring to apply biasing force on the foot 42 without allowing the foot spring to engage the groove 46 as the movable panel 20 is moved.

In some examples, flexibility and pivot action of the foot are achieved via a ball joint connecting the foot and the rod. That is, a ball joint may be disposed at least partially within a bore of the overmold carrier and a con rod having two collars may be connected to the ball joint. The foot may be integrally connected to the two collars and rotates about the ball joint to pivot into and out of engagement with the detents of the guide rail. Optionally, the foot spring may be internal to the carrier, such as disposed between the collar 56 formed within the carrier and a lip or engaging portion formed at the rod and/or foot.

The handle 24 is configured to actuate the panel 20, such as a sliding window, which covers in its closed state an opening, such as a window opening, may include the combination of the locking handle 26, which works essentially by rotating or swiveling and uses at least a flexible element, and an opening handle 28, which works by sliding, has one or more return spring(s) 34 and uses a toothed end pin or pinion 40 on a rod 38, which translates the sliding movement into a rotation.

Furthermore, guide rail elements 22 are arranged to interact with the rod 38. The rod 38 is rotated by the actions exerted on handle parts 26, 28, thus deindexing it from the rails 22. A tension spring can be positioned to press the feet 42 of the toothed axle or rod 38 against friction ribs of guide rails 22 without excessive stress. A user may apply manual pressure P1 (FIG. 2) to the locking handle part 26 to rotate the locking handle part 26 in direction E and retract the locking stops 30 from their locking engagement in the opening handle part 28. The cross-section of the locking handle part 26 is designed to be elastic, either by a choice of suitable plastic material, or by a combination of plastic and spring steel. This elastic construction allows the stops 30 of the handle to reposition themselves in the openings of the opening handle part 28, thus guaranteeing a safety function. A user may apply manual pressure P2 (FIG. 3) to the opening handle part 28 to translate said handle part and to rotate the pinion 40 of the toothed axis or rod 38. Spring(s) 34 is/are compressed and will release when the assembly described is either in the closed position, or in an intermediate opening position of the moveable assembly.

Referring now to FIGS. 5-7, Rotation R of the toothed axle or rod 38 deindexes its feet 42 from the grooves 46 in the guide rails 22, such that the feet 42 are rotationally moved into the bays 44 at certain positions, like end position 46 that can be the closed and/or fully opened position of the panel 20, and intermediate positions 50 that can be somewhere between closed and fully opened positions of the panel 20 of the guide rail 22. Friction forces at the feet 42 of the rod 38 in the guide rails 22 are reduced by the lower surface of the rod 38, such as at the feet 42, coming into contact with ribs on the groove bottoms of the guide rails 22.

The pressure P1, P2 exerted by handle parts 26, 28 enables the feet 42 of toothed shaft or rod 38 to be aligned parallel to the grooves 46 of the guide rails 22, thus enabling the moving assembly to be translated T (FIG. 7) into one of the intermediate opening positions 50, or the end-of-stroke position 46 for maximum opening. The release of pressures P1, P2 on handle parts 26, 28 causes the toothed pin or rod 38 to no longer held in parallel alignment with the direction of the grooves 46 in guide rails 22, and is automatically locked into the intermediate locking bays 44 by the return spring(s) 34.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

The following description pertains to elements set forth in FIGS. 2-7. The concept is a combination of two issues. The first involves unlocking and locking a system by manual manipulation, to meet customer specifications for user safety, particularly for children. The second involves blocking and unblocking the mobile assembly from the fixed assembly in a closed position, and in intermediate open positions as requested by customers in their specifications.

The concept involved in the first problem consists of combining elements called the locking handle 26, which works in rotation and flexibility, the opening handle 28, which works in sliding, the return spring(s) 34 and the toothed end pin 40, which works in rotation.

The concept involved in the second problem consists of combining guide rail elements 22 (which may include guide rail elements 22 at the upper portion of the frame 14 and at the lower portion of the frame 14) and toothed axle 40. The toothed axle 40 is rotated by the actions exerted on handles 26, 28″, thus de-indexing it from rails 22. A tension spring may be positioned to press the feet 42 of toothed axle 40 against the friction ribs of rails 22 without excessive stress.

FIGS. 2-4 show the first problem. The elements concerned are called: locking handle 26, opening handle 28, return spring(s) 34 and toothed pins 40.

To work the first problem, the user may apply manual pressure P1 to handle 26 to rotate it in direction E and retract the two locking stops 30 from the aperture on handle 28. The cross-section of the handle 26 is designed to be elastic, either by a choice of suitable plastic material, or by a combination of plastic and spring steel. This elastic construction allows the stops 30 of handle 26 to reposition themselves in the openings of handle 28, thus guaranteeing the safety function. The user may apply manual pressure P2 to handle 28 to translate said handle and rotate the toothed axis 40 (e.g., see R in FIG. 7). Spring(s) 34 is/are compressed and will release when the assembly described by the second problem is either in the closed position, or in the intermediate opening positions of the movable assembly.

FIGS. 5-7 show the second problem. The elements concerned are called toothed pins 40, guide rails 22, and return spring(s) 34. To work the second problem, rotation R of the toothed axle 40 de-indexes its feet 42 from the rail housings 22. Friction forces at the foot 42 of the toothed pin 40 in the rails 22 are reduced by the lower surface of the pin 40 coming into contact with ribs on the groove bottoms of the rails 22. The pressure P1, P2 exerted by handles 26, 28 enables the feet 42 of toothed shaft 40 to be aligned parallel to the grooves of rails 22, thus enabling the moving assembly to be translated T (FIG. 7) into one of the intermediate opening positions 50 or the end-of-stroke position 48 for maximum opening. The release of pressures P1, P2 on handles 26, 28 means that the toothed pin 40 is no longer held in parallel alignment with the direction of the grooves in rails 22, and is automatically locked into the intermediate locking housings 50 by return spring(s) 34. The release of pressures P1, P2 on handles 26, 28 means that the toothed pin 40 is no longer held in parallel alignment with the direction of the grooves in rails 22, and is automatically housed in the lock housing in the closed moving assembly position 44 under the action of return spring(s) 34.

Thus, the window assembly 10 may include a handle assembly 24 that is coupled to the movable window panel 20 and that is graspable and manually operable by a user when opening and closing the movable window panel 20 relative to the frame 14 and the fixed window panels 16, 18 and/or moving the movable window panel 20 to an intermediate position. The handle assembly 24 includes a locking handle 26 and an opening handle 28 that are movable relative to one another and movable relative to the window panel 20. When a first pressure P1 is applied to the locking handle 26 (e.g., urging the locking handle 26 toward the opening handle 28), the locking handle 26 pivots against the biasing force of the spring bias lock 32 to move the stop 30 out of engagement with the opening handle 28. This allows the opening handle 28 to translate toward the locking handle 26 in response to the second pressure P2 applied by the user.

When the user applies the second pressure P2, the opening handle 28 translates toward the locking handle 26 and the rack 36 of the opening handle 28 engages the toothed pinion 40, causing the rod 38 and foot 42 to rotate or pivot relative to the guide rail 22. This causes the foot 42 to move out of engagement with the detent 44 of the guide rail 22 and into alignment with the groove or channel 46 of the guide rail 22. Thus, the movable panel 22 may be free to move along the guide rail 22 and frame 14 as the foot 42 is aligned with the channel 46.

With the pressure P2 maintained on the opening handle 28 (such as when the movable window panel 20 is moved between the opened position and the closed position), the foot 42 may remain generally aligned with the channel 46 and the window panel 20 may move past detent positions without stopping or engaging the detents 44. With the pressure P2 on the opening handle 28 released, the return spring 34 may urge the opening handle 28 away from the locking handle 26 such that, with the foot 42 at or near a detent 44, the foot 42 may rotate into engagement with the detent 44, causing the toothed pinion 40 to move the rack 36 and opening handle 28 away from the locking handle 26 and moving the stop 30 into engagement with the aperture of the opening handle 28. Accordingly, the window panel 20 may be movable as long as pressure P2 is maintained by the user, and the window panel 20 may stop moving at a detent position 44 based on pressure P2 being released. The user may then again move the movable window panel 20 by applying pressure P1, P2 at the handles 26, 28 (e.g., by squeezing the handles 26, 28 toward one another).

The window panel may comprise a glass window panel, such as transparent tempered glass window panel or the like. Optionally, the window panel may comprise a non-glass material, such as a transparent or substantially transparent plastic or polymeric or acrylic material or the like. Although shown and described as a vehicular rear slider window assembly configured to be disposed at the rear portion of a cabin of a pickup truck, the window assembly may be suitable for other rear windows (such as a liftgate window such as for a hatchback vehicle or van or the like) or side windows (such as fixed side window panels or tilt-to-open side window panels for an SUV or van or the like). For example, the fixed window panel may be disposed at a rear portion of an interior cabin of a pickup truck or SUV that is not equipped with the slider window assembly.

Optionally, the window assembly or assemblies may utilize aspects of the window assemblies described in U.S. Pat. Nos. 11,331,984; 10,501,977; 8,938,914; 8,915,018; 8,881,458; 8,402,695; 8,322,073; 7,838,115; 7,332,225; 7,073,293; 7,003,916; 6,846,039; 6,691,464; 6,319,344; 6,068,719; 5,853,895 and/or 5,799,444, and/or U.S. Publication Nos. U.S.-2021-0355737; U.S.-2014-0047772; U.S.-2013-0174488; U.S.-2011-0056140; U.S.-2006-0107600; U.S.-2008-0127563; U.S.-2004-0020131 and/or U.S.-2003-0213179, which are hereby incorporated herein by reference in their entireties. Although shown and described as a horizontally movable center window that moves relative to a pair of opposite side windows (such as for applications at the rear of a cab of a pickup truck or the like), it is envisioned that aspects described herein are applicable to other types of movable window assemblies, such as horizontally movable window panels that move relative to a single fixed window panel and/or frames (such as for a rear or side opening of a vehicle or the like), and/or such as vertically movable window panels that move relative to one or more fixed panels and/or frames (such as for a rear or side opening of a vehicle or the like).

Changes and modifications in the specifically described embodiments can be carried out without departing from the principles of the invention, which is intended to be limited only by the scope of the appended claims, as interpreted according to the principles of patent law including the doctrine of equivalents.

1. A sliding closure arrangement for a vehicle comprising:
a frame, wherein the frame has at least one side with a guide rail for slidably receiving a closure that is moveable in response to (i) an opening direction force where the closure moves along the guide rail toward an opened position and (ii) a closing direction force where the closure moves along the guide rail toward a closed position;
wherein the closure is moveable to one or more intermediate positions between the opened position and the closed position;
a handle lock mechanism connected to a carrier of the closure and having a locking handle and an opening handle, wherein the locking handle comprises at least one lock stop;
wherein the locking handle is rotatable to move the at least one lock stop between a locked position and an unlocked position;
wherein the locking handle comprises a bias lock spring for biasing the at least one lock stop toward the locked position;
wherein the handle lock mechanism comprises an opening handle having an aperture for receiving the at least one lock stop when the locking handle is rotated to the locked position;
wherein the opening handle comprises a return spring that pushes against the opening handle to bias the opening handle in a direction so that the at least one lock stop moves into the aperture positioning the locking handle in the locked position;
wherein the opening handle comprises a rack having a plurality of teeth for engaging at least one of a plurality of toothed pins rotatably connected to a rod;
a blocking mechanism in sliding contact with the guide rail of the frame, wherein the blocking mechanism is connected to the carrier of the closure, and wherein the blocking mechanism is operably connected to the handle lock mechanism through the rod;
wherein the blocking mechanism includes a blocking spring connected between the carrier and a foot where forces are exerted on the foot;
a detent formed in the guide rail, wherein the foot of the blocking mechanism slides in the guide rail; and
wherein the blocking spring biases the foot to rotate to an engaged position where the foot engages the detent to hold the blocking mechanism and the closure at a location on the guide rail until the opening direction force or closing direction force is exerted on the handle locking mechanism to overcome the force of the blocking spring to move the foot to a released position where the foot is released from the detent.

2. The sliding closure arrangement of claim 1, wherein at least a portion of the rod extends within the carrier, and wherein the carrier includes a threaded surface that the foot connects to and rotates about the threaded surface as the foot moves between the engaged position and the released position.

3. The sliding closure arrangement of claim 2, wherein the blocking spring is in contact and positioned between a flange of the foot disposed within the carrier and a collar formed within the carrier.

4. The sliding closure arrangement of claim 1, wherein at least a portion of the rod extends within the carrier, and wherein the carrier includes (i) a bore through the carrier, (ii) a ball joint connected though the bore and (iii) a con rod having two collars connected to the ball joint, wherein the foot is integrally connected to the two collars and rotates about the ball joint to engage the detent of the guide rail.

5. The sliding closure arrangement of claim 4, wherein the blocking spring is in contact and positioned between a flange of the foot disposed within the carrier and a collar formed within the carrier.

6. A vehicular rear slider window assembly, the vehicular rear slider window assembly comprising:
a fixed window panel;
a movable window panel;
an upper rail and a lower rail attached to the fixed window panel;
wherein the movable window panel is movable along the upper rail and the lower rail between (i) a closed position where the movable window panel is disposed at an opening of the fixed window panel and (ii) an opened position where the movable window panel is disposed at least partially along the fixed window panel;
wherein at least one of the upper rail and the lower rail comprises a channel having a detent;
wherein a detent element is disposed within the channel and is movable along the channel according to movement of the movable window panel between the closed position and the opened position;
wherein the detent element is pivotable within the channel between (i) an engaged position where the detent element engages the detent to limit movement of the movable window panel between the closed position and the opened position and (ii) a disengaged position where the detent element does not engage the detent to allow movement of the movable window panel between the closed position and the opened position;
a handle attached to the movable window panel, wherein the handle comprises an opening portion and a locking portion;
wherein the locking portion is adjustable between (i) a locked state where the locking portion engages the opening portion to limit movement of the opening portion relative to the locking portion and (ii) an unlocked state where the locking portion moves out of engagement with the opening portion to allow movement of the opening portion relative to the locking portion; and
wherein, with the locking portion in the unlocked state, the opening portion is translatable relative to the locking portion, and wherein, as the opening portion translates relative to the locking portion, the opening portion engages a connecting element coupled to the detent element to pivot the detent element from the engaged position toward the disengaged position to allow movement of the movable window panel between the closed position and the opened position.

7. The vehicular rear slider window assembly of claim 6, wherein the connecting element comprises a rod that extends between the handle and the detent element, and wherein the detent element is pivotably coupled to the rod.

8. The vehicular rear slider window assembly of claim 7, wherein a gear element is disposed at a portion of the rod spaced from the detent element, and wherein the opening portion comprises a rack that engages the gear element to pivot the detent element as the opening portion translates relative to the locking portion.

9. The vehicular rear slider window assembly of claim 6, wherein the channel comprises a plurality of detents, and wherein at least a first detent of the plurality of detents corresponds to the opened position of the movable window panel, and wherein at least a second detent of the plurality of detents corresponds to the closed position of the movable window panel.

10. The vehicular rear slider window assembly of claim 9, wherein at least a third detent of the plurality of detents corresponds to an intermediate position of the movable window panel between the opened position and the closed position.

11. The vehicular rear slider window assembly of claim 6, wherein, with the detent element in the engaged position, a longitudinal axis of the detent element is disposed at an angle relative to a longitudinal axis of the channel, and wherein, with the detent element in the disengaged position, the longitudinal axis of the detent element is aligned with the longitudinal axis of the channel.

12. The vehicular rear slider window assembly of claim 6, wherein a rib is formed on a wall of the channel to engage the detent element.

13. The vehicular rear slider window assembly of claim 6, wherein a rib is formed on the detent element to engage a wall of the channel.

14. The vehicular rear slider window assembly of claim 6, wherein the opening portion translates toward the locking portion to pivot the detent element from the engaged position toward the disengaged position, and wherein the opening portion is biased away from the locking portion to bias the detent element toward the engaged position.

15. The vehicular rear slider window assembly of claim 14, wherein the locking portion is biased toward the locked state.

16. The vehicular rear slider window assembly of claim 6, wherein the locking portion is pivotable relative to the opening portion between the locked state and the unlocked state.

17. The vehicular rear slider window assembly of claim 6, wherein the movable window panel is manually movable between the closed position and the opened position.

18. The vehicular rear slider window assembly of claim 6, wherein the fixed window panel comprises a single glass panel having the opening therethrough.

19. The vehicular rear slider window assembly of claim 6, wherein the fixed window panel comprises two fixed glass panels with the opening between the two fixed glass panels.

20. The vehicular rear slider window assembly of claim 6, wherein the vehicular rear slider window assembly is configured to be disposed at a rear portion of a cabin of a pickup truck.
